(19) United States
(12) Patent Application Publication
(10) Pub. No.: US 2025/0381895 A1
(43) Pub. Date: Dec. 18, 2025

(54) SIDE FRAME

(71) Applicant: TOYOTA BOSHOKU KABUSHIKI KAISHA, Aichi (JP)

(72) Inventors: Keisuke YAMAMOTO, Toyota-shi (JP); Ririka AKITA, Toyota-shi (JP)

(73) Assignee: TOYOTA BOSHOKU KABUSHIKI KAISHA, Aichi (JP)

(21) Appl. No.: 19/228,883

(22) Filed: Jun. 5, 2025

(30) Foreign Application Priority Data
Jun. 12, 2024 (JP) 2024-095143

(51) Int. Cl. B60N 2/68

(52) U.S. Cl. CPC B60N 2/68

(57) ABSTRACT

Provided is a side frame forming a portion of a back frame of a seatback. The side frame of the present disclosure includes a first plate part, a second plate part, a third plate part, a reinforcing plate, and an inclined part. The inclined part is provided at a front end side of the reinforcing plate in seat front-rear directions and inclined relative to the first plate part such that the front end side of the reinforcing plate in the seat front-rear directions is located adjacent to the second plate part. The inclined part is surrounded by the first plate part, the second plate part, and the third plate part.

### CROSS-REFERENCE TO RELATED APPLICATIONS

This application claims the benefit of Japanese Patent Application No. 2024-095143 filed on Jun. 12, 2025 with the Japan Patent Office, and the entire disclosure of Japanese Patent Application No. 2024-095143 is incorporated herein by reference.

### BACKGROUND

The present disclosure relates to a side frame for a back frame.

For example, in an invention disclosed in Japanese Unexamined Patent Application Publication No. 2018-162032, two panel frames each having a substantially C-shaped cross-section with one open side in a seat-width direction overlap with each other to form a single side frame.

### SUMMARY

The present disclosure discloses one example of a side frame that can reduce deformation of the side frame, from a different viewpoint from that of conventional side frames.

It is desirable that a side frame forming a portion of a back frame of a seatback comprise at least one of the elements below, for example.

The elements are: a first plate part extending substantially perpendicular to a seat-width direction; a second plate part arranged in a position separated from the first plate part in the seat-width direction, the second plate part extending substantially perpendicular to the seat-width direction; a third plate part connecting a front end side of the first plate part in seat front-rear directions and a front end side of the second plate part in the seat front-rear directions to each other; a reinforcing plate joined to a surface of the first plate part closer to the second plate part; and an inclined part provided at a front end side of the reinforcing plate in the seat front-rear directions, the inclined part being inclined relative to the first plate part such that the front end side of the reinforcing plate in the seat front-rear directions is located closer to the second plate part. Hereinafter, the first plate part, the second plate part, and the third plate part are referred to as a frame body.

The inclined part is surrounded by the frame body. This configuration causes a leading end of the inclined part and the second plate part in the side frame to be brought into contact with each other before the frame body is significantly deformed.

Thus, after the leading end of the inclined part and the second plate part are brought into contact with each other, deformation of the frame body is inhibited due to the presence of the second plate portion, thereby reducing significant deformation of the frame body.

In addition, since the inclined part is inclined relative to the first plate part, it is possible to increase the cross section of the inclined part as well as the flexural rigidity (the second moment of area) of the inclined part, without increasing the dimension of the frame body in the seat front-rear directions, as compared to a configuration in which the inclined part is straight (that is, is not angled).

The side frame may be configured, for example, as described below.

It is desirable that a dimension of the second plate part in the seat front-rear directions be smaller than a dimension of the first plate part in the seat front-rear directions, and an opening to expose the reinforcing plate be located rearward of a rear end side of the second plate part in the seat front-rear directions.

Since such a configuration allows an assembly operator (including an automatic assembly machine) to visually recognize, through the opening, the side where the first plate part is located, it possible to easily assemble, to the first plate part, the reinforcing plate including the inclined part. Thus, it is possible to improve assembly workability and inhibit a yield loss caused by the poor assembly from decreasing.

It is desirable to include a fourth plate part extending in the seat-width direction from a rear end side of the first plate part in the seat front-rear directions, and a flange extending in the seat-width direction from a rear end side of the reinforcing plate in the seat front-rear directions. It is desirable that a dimension of the fourth plate part in the seat-width direction and a dimension of the flange in the seat-width direction be each greater than a dimension of the third plate part in the seat-width direction.

It is desirable that the first plate part have a through hole penetrating in a thickness direction of the first plate part, the reinforcing plate have a through hole penetrating in a thickness direction of the reinforcing plate, and in a state in which the through hole of the first plate part and the through hole of the reinforcing plate are aligned with each other, the reinforcing plate is joined to the first plate part.

In such a configuration, it is desirable that an assembly operator in an assembly work insert a pin into the through hole of the first plate part and the through hole of the reinforcing plate to position the reinforcing plate relative to the first plate part. Thus, it is easier for the assembly operator to position the reinforcing plate and assemble the reinforcing plate to the first plate part.

### BRIEF DESCRIPTION OF THE DRAWINGS

An example embodiment of the present disclosure will be described hereinafter with reference to the accompanying drawings, in which:

FIG. 1 is a diagram of a back frame in a first embodiment;

FIG. 2 is an exploded view of the side frame in the first embodiment;

FIG. 3 is a diagram of the side frame in the first embodiment;

FIG. 4 is a cross-sectional view of the side frame in the first embodiment first embodiment;

FIG. 5A is a diagram of an assembling process (1);

FIG. 5B is a diagram of an assembling process (2);

FIG. 5C is a diagram of an assembling process (3); and

FIG. 6 is a sectional view of a side frame in a second embodiment.

### DETAILED DESCRIPTION OF EXEMPLARY EMBODIMENTS

Below-described embodiments of the invention show examples of the embodiments that fall within the technical scope of the present disclosure. That is, invention-specifying matters and the like recited in the appended claims are not limited to specific configurations, structures, and the like indicated in the embodiments below.

The embodiments below are examples of a seatback in a seat (hereinafter, a vehicle seat) to be mounted in a vehicle, such as an automobile. Arrows indicating directions, hatched lines, and so on shown in the drawings are provided to facilitate understanding of mutual relationships between the drawings, shapes of members or portions, and so on.

The seatback is not limited to the directions shown in the drawings. The directions shown in the drawings are those in a state where the vehicle seat according to the embodiments below is mounted in an automobile. The drawings provided with hatched lines do not always represent sectional views.

A member or portion described at least with a reference numeral is at least one in number except in a case of being accompanied by a restrictive wording such as “only one”. In other words, the member or portion may be two or more in number in a case of not being accompanied by the restrictive wording such as “only one”. The seatback described in the present disclosure comprises at least one of (i) an element such as a member or portion described at least with a reference numeral or (ii) a structural portion shown in the drawings.

### First Embodiment

### <1. Overview of Seatback>

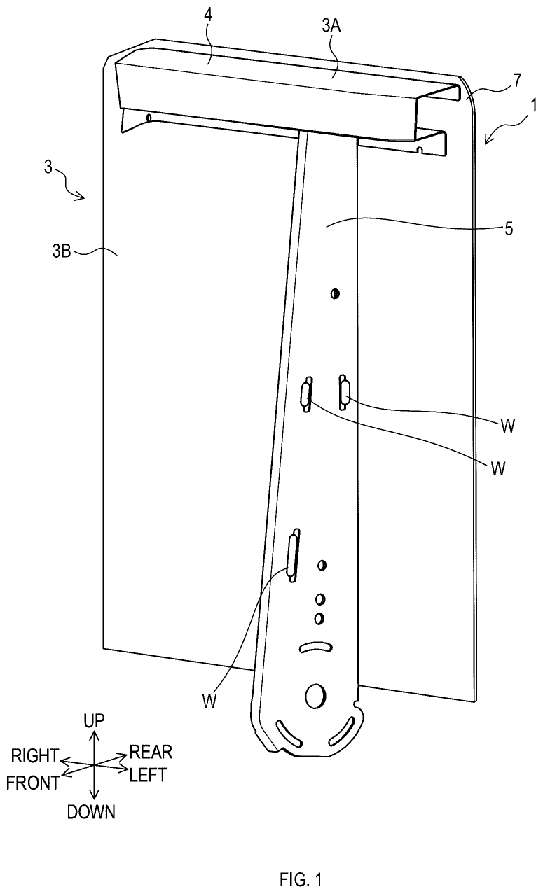

A seatback 1 shown in FIG. 1 is a seatback for a rear seat. The seatback 1 is mounted in a vehicle and supports a back of an occupant. The seatback 1 comprises a back frame 3 and a back cushion (not shown).

The back frame 3 is a strengthening member forming a framework of the seatback 1. The back cushion (not shown) is a cushion member arranged on a front side of the back frame 3. An outer surface of the back cushion is covered by a cover (not shown).

The back frame 3 includes a support frame 3A and a panel frame 3B. The support frame 3A forms a framework having a rectangular shape. The support frame 3A includes an upper frame 4 and a side frame 5.

The upper frame 4 and the side frame 5 are members each forming a portion of the back frame 3. The upper frame 4 is a strengthening member that is located in an upper end portion of the back frame 3 and that extends in the seat-width direction.

The side frame 5 is a member extending in upper and lower directions, and an upper end of the side frame 5 is joined to the upper frame 4. A back panel 7 is a plate-shaped member forming the panel frame 3B. The back panel 7 is joined to the support frame 3A from a rear in seat front-rear directions.

### <2. Details of Side Frame>

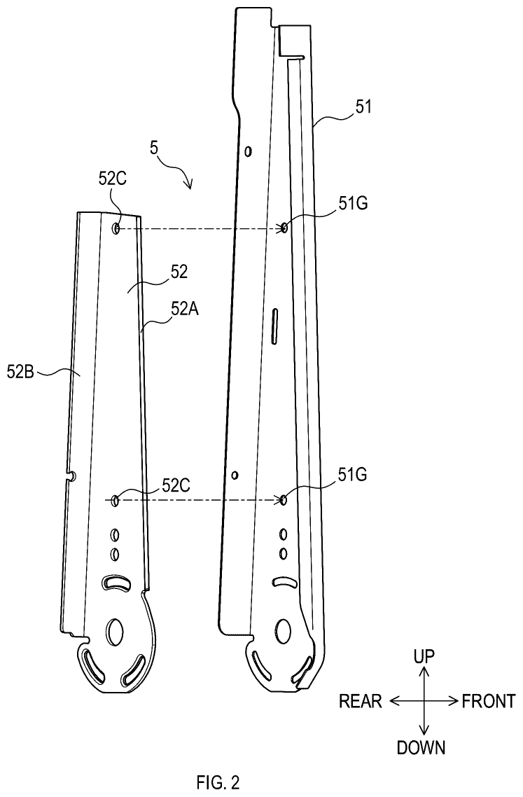

As shown in FIG. 2, the side frame 5 includes a frame body 51 and a reinforcing plate 52. The reinforcing plate 52 is joined to the frame body 51 at plurality of positions.

A first plate part 51A has a through hole 51G penetrating in a thickness direction thereof. The reinforcing plate 52 has a through hole 52C penetrating in a thickness direction thereof.

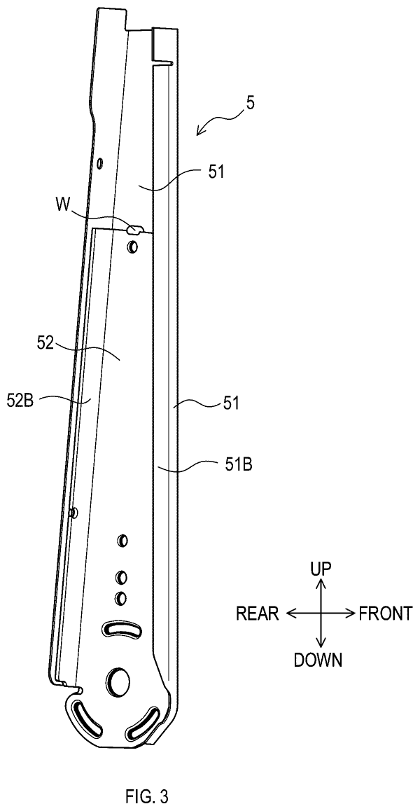

The frame body 51 and the reinforcing plate 52 are welded to each other in a state in which the through hole 51G and the through hole 52C are aligned with each other. Reference numeral W in FIG. 1 and FIG. 3 illustrates welding positions of the frame body 51 and the reinforcing plate 52.

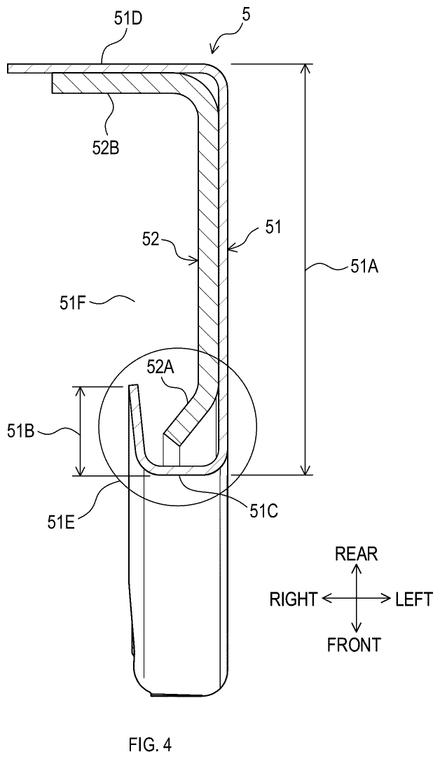

As shown in FIG. 4, the frame body 51 includes the first plate part 51A, a second plate part 51B, a third plate part 51C, and a fourth plate part 51D. The frame body 51 is composed of the first plate part 51A to the fourth plate part 51D integrally formed by applying plastic working to a rolled steel plate, such as a steel plate hot commercial (SPHC).

The first plate part 51A is a plate-shaped portion that is substantially perpendicular to the seat-width direction. The second plate part 51B is a plate-shaped portion that is arranged in a position separated from the first plate part 51A in the seat-width direction (in the present embodiment, toward the right) and that is substantially perpendicular to the seat-width direction.

The third plate part 51C is a plate-shaped portion that connects a front end side of the first plate part 51A in the seat front-rear directions and a front end side of the second plate part 51B in the seat front-rear directions to each other. A plate surface of the third plate part 51C is substantially perpendicular to the seat front-rear directions. The fourth plate part 51D is a plate-shaped portion extending in the seat-width direction from a rear end side of the first plate part 51A in the seat front-rear directions.

The reinforcing plate 52 is a plate-shaped member joined to a surface of the first plate part 51A closer to the second plate part 51B. A front end side of the reinforcing plate 52 in the seat front-rear directions is provided with an inclined part 52A.

The inclined part 52A is a portion inclined relative to the first plate part 51A such that a front end side of the inclined part 52A in the seat front-rear directions is located closer to the second plate part 51B. A rear end side of the reinforcing plate 52 in the seat front-rear directions is provided with a flange 52B. The flange 52B is a portion extending from the rear end side of the reinforcing plate 52 in the seat-width direction (in the present embodiment, toward the right).

The inclined part 52A and the flange 52B are integrally formed as the reinforcing plate 52 by applying plastic working to a rolled steel plate. Hereinafter, unless otherwise specified, the reinforcing plate 52 includes the inclined part 52A and the flange 52B.

The inclined part 52A is housed in a substantially C-shaped portion 51E formed by the first plate part 51A, the second plate part 51B, and the third plate part 51C, so that the inclined part 52A is surrounded by the portion 51E.

A dimension of the second plate part 51B in the seat front-rear directions is smaller than a dimension of the first plate part 51A in the seat front-rear directions, and a rear end side of the second plate part 51B in the seat front-rear directions is not connected to the fourth plate part 51D.

In other words, an opening 51F to expose the reinforcing plate 52 is located rearward of the rear end side of the second plate part 51B in the seat front-rear directions. Thus, an assembly operator, including human workers and automated machines for assembly, can visually recognize, through the opening 51F, the side where the first plate part 51A is located.

A dimension of the fourth plate part 51D in the seat-width direction and a dimension of the flange 52B in the seat-width direction are each greater than a dimension of the third plate part 51C in the seat-width direction. This is intended to avoid interference between the occupant and the side frame 5 while increasing a second moment of area of the side frame 5.

### <3. Features of Side Frame>

### <Structural Feature>

The inclined part 52A of the reinforcing plate 52 in the first embodiment is surrounded by the frame body 51 (see FIG. 4). This configuration causes a leading end of the inclined part 52A and the second plate part 51B in the side frame 5 to be brought into contact with each other before the frame body 51 is significantly deformed.

Thus, after the leading end of the inclined part 52A and the second plate part 51B are brought into contact with each other, deformation of the frame body 51 is inhibited due to the presence of the second plate part 51B, thereby reducing significant deformation of the frame body.

In addition, the inclined part 52A inclined relative to the first plate part 51A allows an increase in the cross-sectional area of the inclined part 52A as well as the flexural rigidity and the second moment of area of the inclined part 52A, without increasing the dimension of the frame body 51 in the seat front-rear directions, as compared to a configuration in which the inclined part 52A is straight (that is, is not angled).

Since the opening 51F to expose the reinforcing plate 52 is located rearward of the rear end side of the second plate part 51B in the seat front-rear directions, an assembly operator can visually recognize, through the opening 51F, the side where the first plate part 51A is located.

This makes it possible to easily assemble, to the first plate part 51A, the reinforcing plate 52 having the inclined part 52A. Thus, it is possible to improve assembly workability and reduce a yield loss caused by the poor assembly.

### <Feature of Assembly Operation>

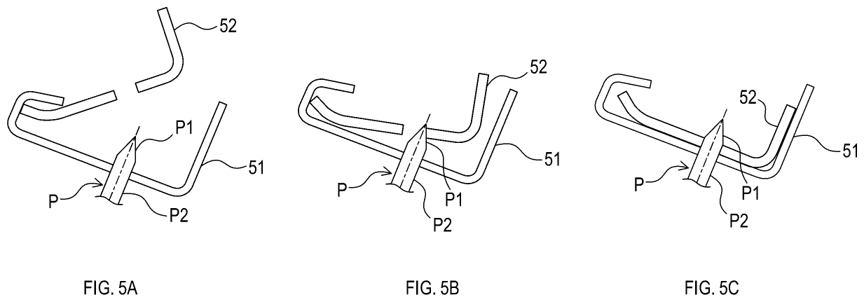

As shown in FIG. 5A to FIG. 5C, an assembly operator in an assembly work inserts a pin P into the through hole 51G of the first plate part 51A and the through hole 52C of the reinforcing plate 52 to position the reinforcing plate 52 relative to the first plate part 51A.

In other words, as shown in FIG. 5A, at an initial stage in the assembly work, the pin P serving as a positioning jig is inserted into the through hole 51G of the frame body 51. Next, as shown in FIG. 5B, the assembly operator attaches the reinforcing plate 52 to the frame body 51 with the inclined part 52A serving as a center of rotation.

At this time, as shown in FIG. 5C, a columnar part P2 of the pin P is guided by a tapered part P1 of the pin P to fit in the through hole 52C of the reinforcing plate 52. Thus, the assembly operator can easily position the reinforcing plate 52 to attach the reinforcing plate 52 to the frame body 51.

### Second Embodiment

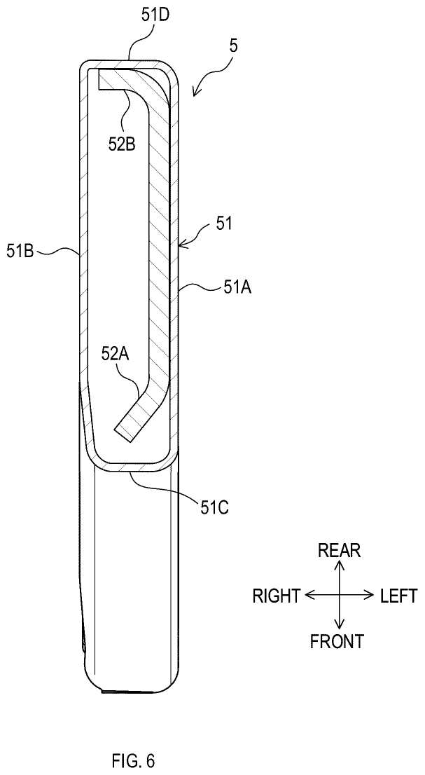

As shown in FIG. 6, the side frame 5 in the second embodiment eliminates the opening 51F. In other words, the frame body 51 has a substantially rectangular shape with a closed cross-section. The same elements and the like as in the first embodiment above are denoted by the same reference numerals as in the above-described embodiment. Thus, redundant explanations are omitted in the second embodiment.

### Other Embodiments

The side frame 5 in the above-described embodiments is a side frame used for a rear seat. However, the present disclosure is not limited thereto. For example, the side frame 5 according to the present disclosure is also applicable to a side frame for a front seat.

In the above-described embodiments, the pin P is inserted to the through hole 51G of the first plate part 51A and the through hole 52C of the reinforcing plate 52, thereby enabling the positioning of the reinforcing plate 52 relative to the first plate part 51A. However, the present disclosure is not limited thereto.

In the above-described embodiments, the vehicle seat according to the present disclosure is applied to an automobile. However, the application of the present disclosure disclosed herein is not limited thereto. For example, the present disclosure is applicable to a seat used in vehicles, such as railroad vehicles, ships, or aircraft, as well as to a stationary seat used in theaters, at home, or in other places.

Moreover, it is sufficient that the present disclosure is consistent with the gist of the disclosure in the above-described embodiments, and the present disclosure is not limited to the above-described embodiments. Therefore, a configuration may be employed in which at least two embodiments among the above-described embodiments are combined together or in which any of the elements shown in the drawings or of the elements described with reference numerals is removed in the above-described embodiments.

What is claimed is:

1. A side frame forming a portion of a back frame of a seatback, the side frame comprising:
a first plate part extending substantially perpendicular to a seat-width direction;
a second plate part arranged in a position separated from the first plate part in the seat-width direction, the second plate part extending substantially perpendicular to the seat-width direction;
a third plate part connecting a front end side of the first plate part in seat front-rear directions and a front end side of the second plate part in the seat front-rear directions to each other;
a reinforcing plate joined to a surface of the first plate part closer to the second plate part; and
an inclined part provided at a front end side of the reinforcing plate in the seat front-rear directions, the inclined part being inclined relative to the first plate part such that a front end side of the inclined part is located closer to the second plate part, the inclined part being surrounded by the first plate part, the second plate part, and the third plate part.

2. The side frame according to claim 1, wherein
a dimension of the second plate part in the seat front-rear directions is smaller than a dimension of the first plate part in the seat front-rear directions, and
an opening to expose the reinforcing plate is located rearward of a rear end side of the second plate part in the seat front-rear directions.

3. The side frame according to claim 2, further comprising:
a fourth plate part extending in the seat-width direction from a rear end side of the first plate part in the seat front-rear directions; and
a flange extending in the seat-width direction from a rear end side of the reinforcing plate in the seat front-rear directions, wherein
a dimension of the fourth plate part in the seat-width direction and a dimension of the flange in the seat-width direction is greater than a dimension of the third plate part in the seat-width direction.

4. The side frame according to claim 1, wherein
the first plate part has a through hole penetrating in a thickness direction of the first plate part,
the reinforcing plate has a through hole penetrating in a thickness direction of the reinforcing plate, and
in a state in which the through hole of the first plate part and the through hole of the reinforcing plate are aligned with each other, the reinforcing plate is joined to the first plate part.
